(19) United States
(12) Patent Application Publication
(10) Pub. No.: US 2007/0011271 A1
(43) Pub. Date: Jan. 11, 2007

(54) Multi-source data retrieval system

(76) Inventors: David V. Baker, Morgantown, WV (US); Trevor M. Harris, Morgantown, WV (US); Doru Ioan Pacurari, Morgantown, WV (US); Takamitsu Kawai, Morgantown, WV (US)

Correspondence Address: KRAMER & AMADO, P.C., 1725 DUKE STREET, SUITE 240, ALEXANDRIA, VA, 22314, US

(21) Appl. No.: 11/436,601

(22) Filed: May 19, 2006

Related U.S. Application Data
(60) Provisional application No. 60/683,055, filed on May 20, 2005.

(51) Int. Cl. G06F 15/16

(52) U.S. Cl. 709/217

(57) ABSTRACT

A multi-source data retrieval system is shown. The system includes a list retriever for retrieving a list of data sources and a graphical user interface for presenting the list of data sources to a user. A fetch manager retrieves information about the data sources and downloads information from the data sources. A data combiner combines the downloaded information into composite data for use by another application.

### CROSS-REFERENCE TO RELATED APPLICATIONS

This application claims the benefit of U.S. Provisional Application No. 60/683,055, filed May 20, 2005.

### BACKGROUND

Various applications in use today make use of remotely stored information. This remotely stored information is sometimes referred to as data sources. These applications are written to include references to the particular data source used. The data sources, however, may change, move, or disappear over time. With the advent of XML and SOAP, new data sources are being made available to applications on a regular basis. Additionally, these data sources may move or change in a relatively short amount of time. Applications that are written to include references to data sources may quickly become out of date or useless as the data sources change, move or disappear. This requires the application provider to rewrite a portion of the application and provide an update or patch to the user of the application. This can be costly to the application provider and annoying to the user of the application.

What is needed is a method and system to download information from multiple data sources in a manner that is independent of the application and that allows a user to flexibly choose information to download from various sources that may change over time.

### SUMMARY

According to an embodiment, a multi-source data retrieval system includes a list retriever for retrieving a list of data sources and a graphical user interface for presenting the list of data sources to a user. A fetch manager retrieves information about the data sources and downloads information from the data sources. A data combiner combines the downloaded information into composite data for use by another application.

### BRIEF DESCRIPTION OF THE DRAWINGS

Examples of the invention are illustrated, without limitation, in the accompanying figures in which like numeral references refer to like elements, and wherein:

FIG. 1 shows an environmental view of a multi-source data retrieval system in accordance with an example;

FIG. 2 shows a simplified diagram of a multi-source data retrieval system in accordance with an example;

FIG. 3 shows a simplified diagram of an interface of a multi-source data retrieval system in accordance with an example;

FIG. 4 shows a flow diagram of a method of retrieving data from multiple sources in accordance with an example;

FIG. 5 shows a flow diagram of a method of retrieving data from multiple sources in accordance with another example; and

FIG. 6 shows a block diagram of a computer system wherein the examples may be implemented.

### DETAILED DESCRIPTION

For simplicity and illustrative purposes, the principles are shown by way of examples of systems and methods described. In the following description, numerous specific details are set forth in order to provide a thorough understanding of the examples. It will be apparent however, to one of ordinary skill in the art, that the examples may be practiced without limitation to these specific details. In other instances, well known methods and structures are not described in detail so as not to unnecessarily obscure understanding of the examples.

In an example, a multi-source data retrieval system retrieves information from a plurality of data sources. The multi-source data retrieval system includes an interface that allows a user to select a list of data providers. For each possible data provider, the user may select portions of the data that are of interest and combine the data from the multiple data providers in a customizable manner.

The multi-source data retrieval system may also be referred to herein as a Customizable User Toolkit for Everywhere or “CUTE.” The CUTE system allows a user to select and retrieve desired information from a list of available data providers. The CUTE system may connect to a central server to fetch “common” map services. The CUTE system may be configured as a module and checks this list against a local cache of map service capability files it may already have in local cache. In the event that CUTE does not have a local cached copy of the map service capabilities file from each specified map service, it queries the map service provider(s) to fetch the respective capabilities file for each service. CUTE may mix and match using locally stored capability files and fetching “fresh” versions from the map service(s). The list of available data providers is retrieved from a database and parsed to create a logical menu hierarchy. The user then selects data providers and portions of data of interest layers from those data providers to be retrieved and combined. The resultant data is then stored locally and can be accessed by a variety of applications. If a user wants to add additional data providers, the CUTE system accepts a location capabilities URL that requests a description of the capabilities available from the specified or intended data provider. The new provider is then available for use with the CUTE system. In this manner, the user may perform “on demand” changes to the available data.

The CUTE system may be used, for example, with a virtual reality geographic information system. In this case, the CUTE system includes an interface that allows users to select a list of map service providers. For each possible map service provider, the user may select the map layers of interest. By combining the desired layers for a specified location, the CUTE system creates a composite image of all the map layers selected by the user. The resulting composite image is used by the virtual reality geographic information system as a drape over a 3-D terrain. This information is not limited to 3D terrain and may be viewed simply as a 2D map via a WWW browser, printed image, or digital image that is draped onto a 2.5D terrain model. Geographical information specialists sometimes refer to this model as 2.5D because it contains an X, Y, and an attribute, in this case elevation value Z. Virtual Reality specialist sometimes refer to this model as 3D because it contains what some consider X, Y, and Z data.

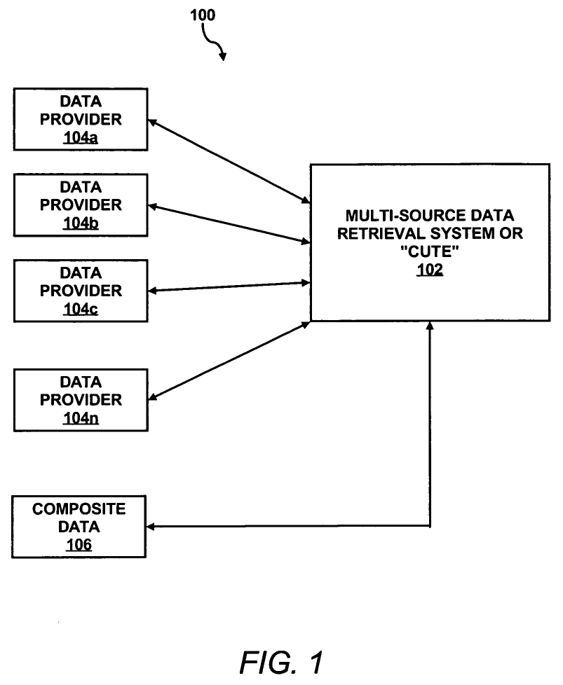

With reference first to FIG. 1, there is shown a system 100 including a multi-source data retrieval system (or CUTE system) 102 for retrieving information from multiple data providers 104a-104n, where n can be any number. The CUTE system 102 retrieves information from the data providers 104a-104n and creates combines this data to create composite data 106. This composite data 106 may be stored locally and used by other applications.

For example, when project lead is identifying potential of a site for construction of a large urban project, i.e., a mall, hospital, etc, they can easily incorporate data from map services which may offer aerial imagery, existing roads network, proposed roads network, proposed topological changes due to excavation, underground utilities, parking, etc. All of these layers can then be turned on/off, and composited with other data to provide the planner with a vast amount of information. This enables better planning, and helps convey to investors, etc what the proposed development will require and look like upon completion.

In another example, a user may want to research companies to determine which stock to buy for a long term investment. Various data providers may have different types of information for the companies the user is interested in researching. Through the CUTE system 102, the user may designate some or all of the data providers 104a-104n to retrieve different types of information about the companies. For instance, one data provider may provide current and historical stock prices while another may provide information on all litigation on which the company was listed as a defendant. Yet another data provider may provide option information or information on a company's officers. The CUTE system 102 retrieves this information from the multiple data providers 104a-104n and creates composite data 106. The composite data 106 may include all the information about the companies and areas of interest designated by the user. This information may be stored locally and used by another application for analysis or display purposes.

The Cute system fetches geographically referenced raster and vector data providers. The requests to each data provider consists of the desired layer(s) to pull imagery from, the bounding envelope in geographic coordinates, either Lat/Long or UTM, requested retrieved image size (in pixels, ie, 1024×1024). This is the basic format of the map service request string made by CUTE to map services. CUTE does additional tasks by allowing the calling user application to specify these parameters, plus parameters to set the level of image compression on the retrieved image (compression done by CUTE to each retrieved image from each map service). CUTE also adjusts image opacity during the composition stage of merging multiple data images. CUTE can also check against its local cache of previously retrieved imagery from map services and can be instructed to use previously cached imagery from the desired map service(s) so long as it has the same properties (i.e., envelope, resolution, compression). Since some map service data changes very infrequently (years), once a sizable cache of previously fetched image tiles is on local disk, it reduces the network demands by CUTE. Of course, new locations that the user hasn't requested before then need to be fetched from the map services, but are then cached to local disk for potential future use. Aerial imagery is relatively static imagery, and is updated rarely in most “non military” cases. For instance, periodically check Google's aerial imagery for your home and you'll notice that it may not reflect your new addition, or your house . . . for years. Other map services are updated frequently, i.e, weather based map services. CUTE can be set to ALWAYS fetch on request, or ALWAYS check local cache, or any combination in between. It's completely configurable.

This approach to retrieving data from multiple sources provides several benefits to a user. The user may easily and readily determine what type of information to retrieve and what type of information to ignore. For example, the user may not be interested in data from data provider 104a and will not designate that data provider 104a as a data source. Therefore, the CUTE system 102 will not retrieve information from the data provider 104a and not include that information in the composite data 106. This may be especially beneficial if the download times are significant or if a particular data provider charges for access to information. The user may also find it easier to incorporate new sources of information as they become available. Through a graphical user interface of the CUTE system 102, described below, the user may add another data provider to the list without having to modify or change the application using the composite data 106 or the CUTE system 102 itself. This reduces the costs the time associated with using existing software. It also extends the useful life of existing software.

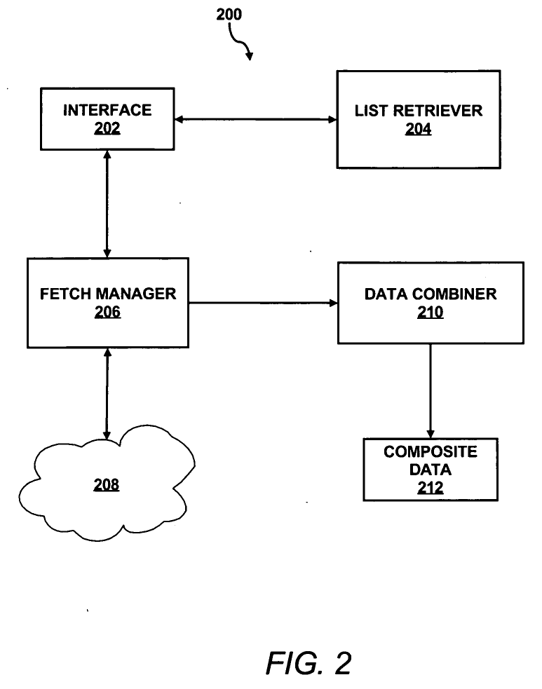

With reference now to FIG. 2, there is shown one possible layout of a CUTE system 200. The CUTE system 200 includes an interface 202, a list retriever 204, a fetch manager 206, and a data combiner 210. The interface 202 allows a user to select data providers or particular portions of data from the data providers for retrieval. Additionally, the interface 202 allows the user to add additional data providers to the list of data providers available. The interface 202 communicates with the list retriever 204. The list retriever 204 may be a module or program for retrieving a list from a database, program, or other data source. Alternatively, the list retriever 204 may simply be a data base of all data providers currently available to the CUTE system 200. The interface 202 is initially populated from the information contained in or discovered from the list retriever 204.

The interface 202 communicates with the fetch manager 206. The fetch manager 206 is in charge of retrieving information from all the data providers indicated by the user. The fetch manager 206 may access the data providers or data sources through the internet 208 or any other network or data connection. The fetch manager 206 may work in a multi-threaded manner retrieving information from multiple data providers simultaneously. This multi-threaded access reduces the total amount of time used in retrieving data. Once all of the data is retrieved by the fetch manager 206, the data is sent to the data combiner 210. The data combiner 210 combines the information to produce composite data 212. The information may be combined in a variety of manners. For example, in the virtual reality geographic information system briefly described above, the information may be combined by geographic location. In another example, as in the company investment described above, the information may be combined based on stock symbol or company name. The manner of combining information is practically limitless and may be designated by the user of the CUTE system 200. The CUTE system may return a filename for each composited image that the CUTE enabled application then retrieves knowing that it's now available from disk to be loaded into the CUTE enabled application.

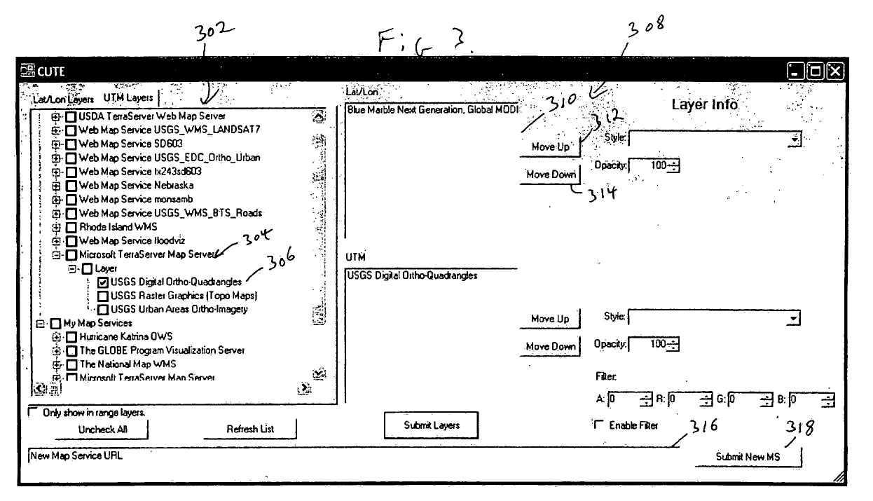

Referring now to FIG. 3, there is shown an example of graphical user interface 300 for a CUTE system 200. The graphical user interface 300 is described with reference to the virtual reality geographic information system briefly described above. The graphical user interface 300 includes a list 302 of data providers. The data provider 304 is expanded to display the different portions of information which may be retrieved. The user, in this case, has selected USGS Digital Ortho-Quadrangles 306 to retrieve from the Microsoft TerraServer Map Server data provider 304. The user may also designate in area 308 how to include this information in the composite data. The layering of the data is shown in box 310 and the user may control the composite priority of the layers by moving information up or down using controls 312 and 314.

A filter may also be included which allows a user to combine a color to the composite mixture of imagery. The higher the Alpha channel ‘A’, the more weight the filter color has when composited with the fetched imagery. The ‘R’, ‘G’, ‘B’ correspond to red, green, blue.

The checkbox for “enable filter” can toggle the filter on/off. The opacity controls the translucency of each individual layer under the Lat/Lon and UTM headings. It's a value that is unique to EACH layer and is default at 100. If we want to blend the USGS Digital Ortho-Quadrangle (DOQ) “aerial imagery” as the dominant image, with data from another service, we keep the USGS DOQ at opacity of 100, but may want to soften the other layer's opacity to 50 so that we achieve a nice blended image. These opacity settings are a unique feature of CUTE for each layer, and are used CUTE-side, not map server side. Style allows the user to select from available “styles” provided via the map service. The result is added into the CUTE composite image.

The graphical user interface 300 also includes a text box 316 and a control 318 for allowing the user to enter a new data provider and updating the list 302 of data providers. The user may enter a new location for the data provider such as a URL. The CUTE system 200 would then query the data provider through the fetch manager 206, shown in FIG. 2, to download information about the data provider. This meta-information includes information about the data available to download by the CUTE system 200. In this manner, the user may extend the ability of the application relying on the composite data without ever modifying the application itself.

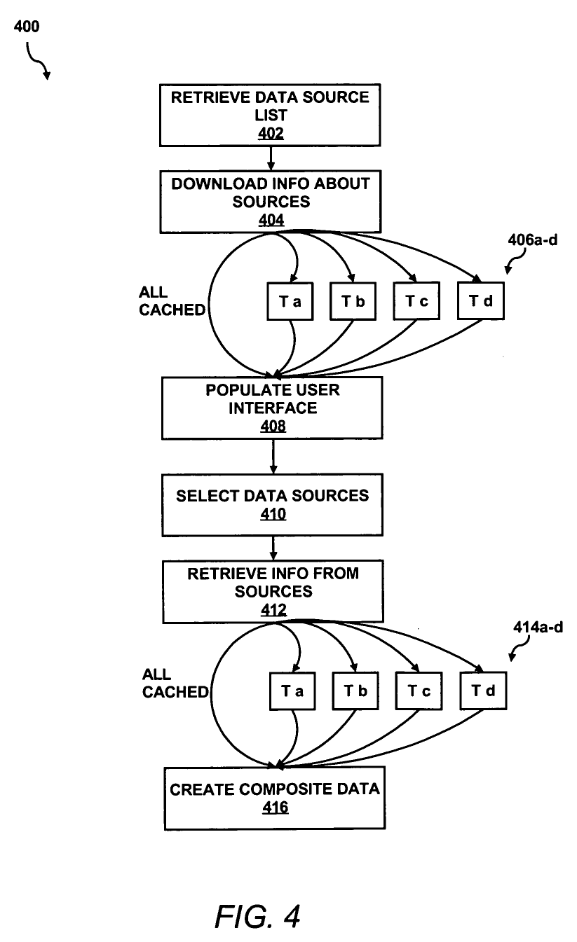

FIG. 4 shows a flow diagram of a method 400 for retrieving data from multiple sources. The following description of the method 400 is made with reference to the system 200 illustrated in FIG. 2, and thus makes reference to the elements cited therein. The following description of the method 400 is one manner in which the system 200 may be implemented. In this respect, it is to be understood that the following description of the method 400 is but one manner of a variety of different manners in which such a system may be operated.

In the method 400, the list retriever 204 retrieves the list of data providers, the data sources, for the CUTE system 200 at step 402. The fetch manager 206 then downloads information about the data sources from the data source or providers themselves at step 404. If the information has already been retrieved and is all cached, the process moves to step 408. If the information is not cached, a plurality of download threads Ta-Td may be created at steps 406a-406d. Once all the information is cached, the graphical user interface 202 is populated with the data providers at step 408. The user then selects the data providers and particular information from each data provider selected to retrieve at step 410. The fetch manager 206 retrieves data from the data providers at step 412. In some cases, this information may already be cached and the process moves to step 416. If all the information is not cached, a plurality of retrieval threads Ta-Td may be created at steps 414a-414d. Once all the information is cached, the fetch manager 206 sends the information to the data combiner 210 which creates the composite data 212 at step 416.

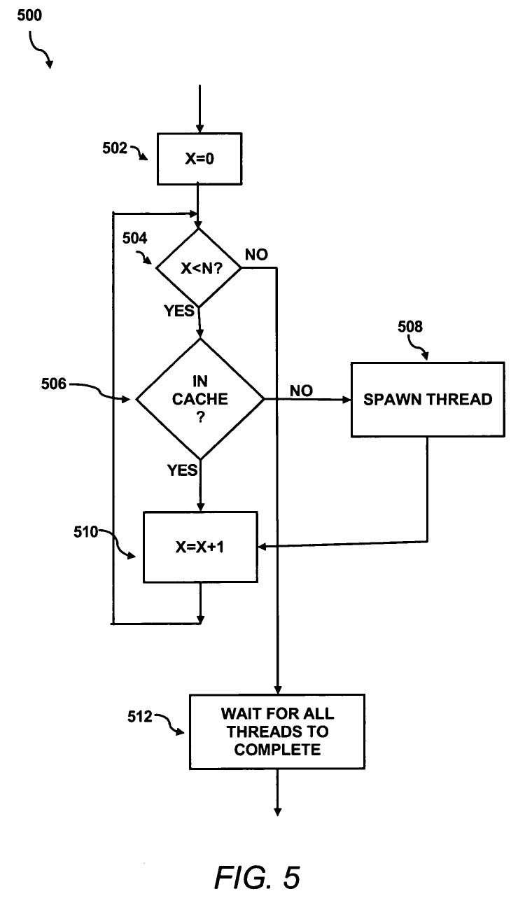

FIG. 5 shows a flow diagram of a method 500 for downloading or retrieving data from multiple sources in a multi-threaded manner. The following description of the method 500 is made with reference to the system 200 illustrated in FIG. 2, and thus makes reference to the elements cited therein. The following description of the method 500 is one manner in which the system 200 may be implemented. In this respect, it is to be understood that the following description of the method 500 is but one manner of a variety of different manners in which such a system may be operated.

In the method 500, the fetch manager 206 determines how many data providers are to be used to download information, assigns this number as the variable N, and sets X equal to zero at step 502. The fetch manager 206 then determines if X is less than N at step 504. If no, then the process moves to step 512. If yes, then the fetch manager 206 determines if the information from the data provider is in the cache at step 506. If the information is cached, the fetch manager 206 increments X by 1 and the process moves to step 504. If the information is not cached, the fetch manager spawns a thread to retrieve the information from the data provider at step 508. The fetch manager 206 increments X by 1 at step 510. The process then continues at step 504. Threads are spawned and the process continues until all the information from all the data sources is retrieved. Once all iterations are complete, the fetch manager waits for all threads to complete the retrieval process at step 512. The information is then sent to the data combiner 210 as described in the method 400.

Some of the steps illustrated in the methods 400 and 500 and all or parts of the system may be contained as a utility, program, subprogram, in any desired computer accessible medium. In addition, the methods 400 and 500 and the systems shown in 100-300 may be embodied by a computer program or a plurality of computer programs, which may exist in a variety of forms both active and inactive in a single computer system or across multiple computer systems. For example, they may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

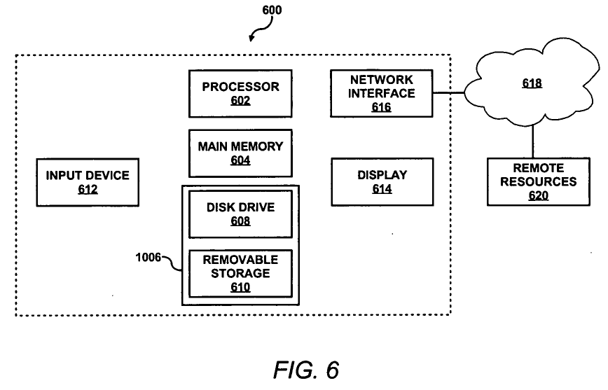

FIG. 6 illustrates an exemplary block diagram of a computer system 600 that may implement some of the systems or methods shown in FIGS. 1-5. The computer system 600 includes one or more processors, such as processor 602, providing an execution platform for executing software. The processor 602 may also execute an operating system (not shown) for executing the software in addition to performing operating system tasks.

The computer system 600 also includes a main memory 604, such as a Random Access Memory (RAM), providing storage for executing software during runtime and mass storage 606. The mass storage 606 may include a hard disk drive 608 and/or a removable storage drive 610, representing a floppy diskette drive, a magnetic tape drive, a compact disk drive, or a nonvolatile memory where a copy of software or data may be stored. Applications and resources may be stored in the mass memory 606 and transferred to the main memory 604 during run time. The mass memory 606 may also include ROM (read only memory), EPROM (erasable, programmable ROM), EEPROM (electrically erasable, programmable ROM).

A user interfaces with the computer system 600 with one or more input devices 612, such as a keyboard, a mouse, a stylus, or any other input device and views results through a display 614. A network interface 616 is provided for communicating through a network 618 with remote resources 620. The remote resources 620 may include servers, remote storage devices, data warehouses, or any other remote device capable of interacting with the computer system 600.

What has been described and illustrated herein are examples of the systems and methods described herein along with some of their variations. The terms, descriptions and figures used herein are set forth by way of illustration only and are not meant as limitations. Those skilled in the art will recognize that many variations are possible within the spirit and scope of these examples, which intended to be defined by the following claims and their equivalents in which all terms are meant in their broadest reasonable sense unless otherwise indicated.

What is claimed is:

1. A multi-source data retrieval system comprising:
a list retriever for retrieving a list of data sources;
a graphical user interface for presenting the list of data sources to a user;
a fetch manager for retrieving meta-information about the data sources and downloading information from the data sources; and
a data combiner for combining the downloaded information into composite data for use by another application.

2. The system of claim 1, wherein the fetch manager comprises a multi-threaded download manager for downloading the information from each of the data sources in a separate thread.

3. The system of claim 1, wherein the fetch manager comprises a multi-threaded download manager for downloading the meta-information about each of the data sources in a separate thread.

4. The system of claim 1, wherein the graphical user interface comprises of a display area for presenting at least a portion of the data available for download from one of the data sources.

5. The system of claim 1, wherein the graphical user interface comprises a display area for allowing the user to designate how to combine data downloaded from the data sources.

6. The system of claim 1, wherein the graphical user interface comprises a control for allowing the user to enter a new data source.

7. A method of retrieving and combining data from multiple data sources, the method comprising:
allowing a user to select the multiple data sources from a plurality of data sources;
retrieving data from each of the multiple data sources in a multi-threaded manner; and
combining the retrieved data into a composite data source.

8. The method of claim 7, wherein the step of retrieving data further comprises for each of the multiple data sources, spawning a thread for retrieving information if a local cache does not exist.

9. The method of claim 7, further comprising waiting for all data to be retrieved before combining the retrieved data into a composite data source.

10. The method of claim 7, further comprising retrieving a list of the plurality of data sources from another application.

11. The method of claim 10, further comprising downloading meta-information about the plurality of data sources in a multi-threaded manner.

12. The method of claim 11, wherein the step of downloading meta-information further comprises for each of the plurality of data sources, spawning a thread for downloading information if a local cache does not exist.

13. The method of claim 12, further comprising populating a graphical user interface with a list of the plurality of data sources and the downloaded meta-information for each of the plurality of data sources.

14. The method of claim 7, further comprising presenting a graphical user interface to the user, the graphical user interface including a list of the plurality of data sources and meta-information about each of the plurality of data sources.

15. The method of claim 14, wherein presenting the graphical user interface to the user further comprises presenting an option to the user to combine only portions of the data available from the plurality of data sources.

16. A computer readable storage medium on which is embedded one or more computer programs, the one or more computer programs implementing a method for retrieving and combining data from multiple data sources, the one or more computer programs comprising a set of instructions for:
allowing a user to select the multiple data sources from a plurality of data sources;
retrieving data from each of the multiple data sources in a multi-threaded manner; and
combining the retrieved data into a composite data source.

17. The computer readable storage medium according to claim 16, said one or more computer programs further comprising a set of instructions for spawning a thread for each of the multiple data sources.

18. The computer readable storage medium according to claim 16, said one or more computer programs further comprising a set of instructions for retrieving a list of the plurality of data sources from another application.

19. The computer readable storage medium according to claim 18, said one or more computer programs further comprising a set of instructions for downloading meta-information about the plurality of data sources in a multi-threaded manner and populating a graphical user interface with a list of the plurality of data sources and the downloaded meta-information for each of the plurality of data sources.

20. The computer readable storage medium according to claim 16, said one or more computer programs further comprising a set of instructions for presenting a graphical user interface to the user, the user interface including a list of the plurality of data sources and meta-information about each of the plurality of data sources and presenting an option to the user to combine only portions of the data available from the plurality of data sources.
